(19) United States
(12) Patent Application Publication
(10) Pub. No.: US 2009/0028686 A1
(43) Pub. Date: Jan. 29, 2009

(54) ROBOTIC PALLETIZING SYSTEM

(75) Inventors: Christopher Tallis, Rochester, MI (US); Erwin DiMalanta, Oxford, MI (US); Donald Stillman, Lake Orion, MI (US)

Correspondence Address: ABB INC.;LEGAL DEPARTMENT-4U6, 29801 EUCLID AVENUE, WICKLIFFE, OH, 44092, US

(73) Assignee: ABB INC., Norwalk, CT (US)

(21) Appl. No.: 12/177,552

(22) Filed: Jul. 22, 2008

Related U.S. Application Data
(60) Provisional application No. 60/951,381, filed on Jul. 23, 2007.

(51) Int. Cl. B65G 47/24

(52) U.S. Cl. 414/793.4

(57) ABSTRACT

A robotic palletizing system is provided for receiving objects from a conveyor and loading the objects on a pallet using a robot having an articulated arm assembly. A lift station is located below the robot and includes a lift assembly that is operable to raise an object in a lift area of the lift station to a pick position from which the robot can grasp the object. When the lift is raising an object, a barrier is raised to prevent any other objects from moving into the lift area. A sensor is operable to detect objects moving into the lift area and a sensor bank is operable to detect the presence and size of any objects in the lift area.

### CROSS-REFERENCE TO RELATED APPLICATION

This application claims the benefit of U.S. provisional patent application No. 60/951,381 filed on Jul. 23, 2007, which is hereby incorporated by reference in its entirety.

### BACKGROUND OF THE INVENTION

The present invention is directed toward palletizing objects and more particularly toward a robotic system for palletizing objects.

Removing objects from a conveyor line and loading them onto a pallet or other carrier or holding structure that may be moved or shipped to another location is typically referred to as “palletizing” objects. Palletizing is typically performed in manufacturing operations and delivery operations, such as delivering mail and parcels. Various types of palletizing systems are known and include manual systems, unitizing systems and robotic systems. In a manual system, humans transfer objects from a conveyor line and place them on a pallet. In a unitizing system, objects are collected together, i.e., accumulated, on the conveyor line and then transferred as a unit to a pallet. In a robotic system, a robot removes individual objects from a conveyor line and loads them on a pallet in a predetermined manner.

Generally, there are two different types of robotic palletizing systems: gantry robotic palletizing systems and pedestal robotic palletizing systems. In a gantry robotic palletizing system, a gantry robot moves along a track mounted above a conveyor line. An example of a gantry robotic palletizing system is disclosed in U.S. Pat. No. 6,579,053 to Grams et al. In a pedestal robotic palletizing system, an articulated arm is movably mounted to a column or pedestal, which is anchored to the floor adjacent to a conveyor line. Examples of pedestal robotic palletizing systems are disclosed in U.S. Pat. No. 4,641,271 to Konishi et al., U.S. Pat. No. 5,085,556 to Ohtomi, U.S. Pat. No. 5,348,440 to Focke, U.S. Pat. No. 5,501,571 to Van Durrett et al. Both types of robotic palletizing systems have their advantages and disadvantages. Pedestal robotic palletizing systems tend to be more adaptable than gantry robotic systems, but require more floor space.

Based on the foregoing, it would desirable to provide a robotic palletizing system that is both adaptable and requires reduced floor space. The present invention is directed to such a robotic palletizing system.

### SUMMARY OF THE INVENTION

In accordance with the present invention, a robotic palletizing system is provided for receiving objects from a conveyor and loading the objects on a pallet. The robotic palletizing system includes a robot and a lift station. The robot has a base, an articulated arm assembly mounted to the base and a gripping device connected to the articulated arm assembly. The lift station is located below the base of the robot and includes a stop assembly, a lift assembly, a control system and a conveying path over which the objects may move. The conveying path has a hold area and a lift area. The stop assembly has a barrier movable between a blocking position, wherein the barrier obstructs movement over the conveying path between the hold area and the lift area, and a release position, wherein the barrier does not obstruct movement over the conveying path between the hold area and the lift area. The lift assembly has a lift operable to raise any of the objects located in the lift area above the conveying path to a pick position from which the robot can grasp the object with the gripping device. The control system is connected to the stop assembly and the lift assembly and is operable to control the movement of the barrier from the release position to the blocking position to prevent any of the other objects from moving from the hold area to the lift area when the lift is raising the object to the pick position.

Also provided in accordance with the present invention is a robotic palletizing system for receiving objects from a conveyor and loading the objects on a pallet, wherein the robotic palletizing system includes a plurality of conveying paths over which the objects may move. The conveying paths are spaced-apart and each include a lift station having a lift for lifting the objects to a pick position. At least one of the conveying paths extend through a table. A robot is mounted on top of the table and is operable to grasp the objects from the pick positions at the lift stations. The robot includes a base, an articulated arm assembly mounted to the base and a gripping device connected to the articulated arm assembly.

Also provided in accordance with the present invention is a lift station for receiving objects of different sizes from a conveyor and presenting them for pick-up by a robot. The lift station includes a stop assembly, a lift assembly, a sensor assembly, a controls system and a conveying path over which the objects may move. The conveying path has a hold area and a lift area. The stop assembly has a barrier movable between a blocking position, wherein the barrier obstructs movement over the conveying path between the hold area and the lift area, and a release position, wherein the barrier does not obstruct movement over the conveying path between the hold area and the lift area. The lift assembly has a lift operable to raise any of the objects located in the lift area above the conveying path to a pick position from which the robot can grasp the object. The sensor assembly includes a first sensor operable to detect any of the objects passing from the hold area to the lift area, and a sensor arrangement disposed proximate to the lift area. The sensor arrangement is operable to detect the presence of any of the objects in the lift area and to transmit object information. The control system is connected to the stop assembly, the lift assembly and the sensor assembly. The control system is operable to control the movement of the barrier from the release position to the blocking position to prevent any of the other objects from moving from the hold area to the lift area when the lift is raising one of the objects to the pick position. The control system is further operable to determine the location and size of any of the objects located in the lift area using the object information from the sensor arrangement.

### BRIEF DESCRIPTION OF THE DRAWINGS

The features, aspects, and advantages of the present invention will become better understood with regard to the following description, appended claims, and accompanying drawings where:

FIG. 1 is a top plan view of a robotic palletizing system embodied in accordance with the present invention, wherein the robotic palletizing system has a plurality of lift stations;

FIG. 2 is a front perspective view of a portion of the robotic palletizing system showing a robot mounted above one of the lift stations;

FIG. 3 is a perspective view of a gripper assembly connected to an arm of the robot;

FIG. 4 is a side view of the gripper assembly;

FIG. 5 is a side view of the gripper assembly holding an object;

FIG. 6 is a top plan view of one of the lift stations;

FIG. 7 is a sectional view of one of the lift stations showing a stop assembly;

FIG. 8 is a sectional view of one of the lift stations showing a lift assembly;

FIG. 9 is a side perspective view of a portion of one of the lift stations; and

FIG. 10 shows a schematic view of the robot palletizing system.

### DETAILED DESCRIPTION OF ILLUSTRATIVE EMBODIMENTS

It should be noted that in the detailed description that follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

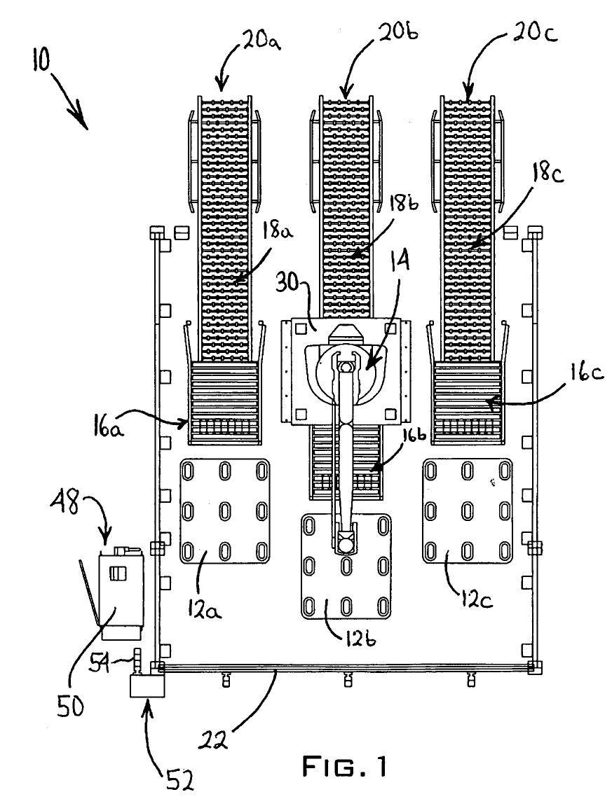

Referring now to FIG. 1 there is shown a top plan view of a robotic palletizing system 10 embodied in accordance with the present invention. The robotic palletizing system 10 is especially suitable for loading objects of various sizes onto one or more pallets 12. The robotic palletizing system 10 generally includes a robot 14, one or more lift stations 16 and one or more conveyor sections 18. In the embodiment shown in FIG. 1, the robotic palletizing system 10 is shown with three lift stations 16a, 16b, 16c connected to three conveyor sections 18a, 18b, 18c so as to form three spaced-apart conveying paths 20a, 20b, 20c, respectively. A fence 22 may be disposed around the robotic palletizing system 10 for safety purposes.

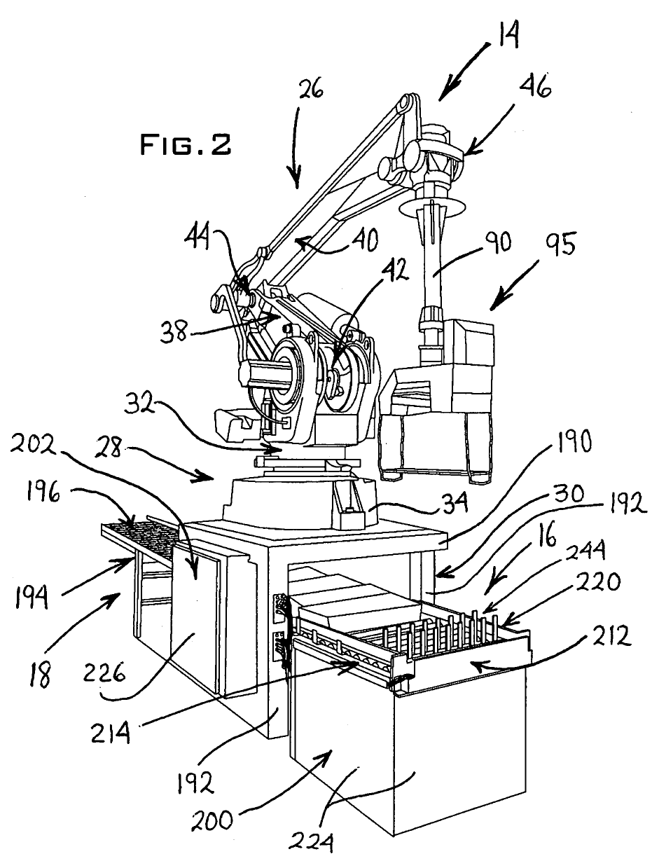

Referring now to FIG. 2, the robot 14 is a multi-axis robot and generally includes an articulated arm assembly 26 mounted to a pedestal or base 28. The base 28 is secured to a table 30 (as will be described in more detail below) and includes a turret 32 rotatably connected to a mount 34 so as to be rotatable around a vertical first axis. The articulated arm assembly 26 includes lower and upper arms 38, 40. An inner end of the lower arm 38 is pivotally connected to the base 28 by a waist joint 42 so as to be pivotable about a horizontal second axis. An outer end of the lower arm 38 is pivotally connected to a lower end of the upper arm 40 by an elbow joint 44 so as to be pivotable about a horizontal third axis. An outer end of the upper arm 40 is connected by a wrist 46 to a gripper assembly 95. The wrist 46 permits the gripper assembly 95 to rotate about at least a fourth axis. The movement of the different parts of the robot 14 relative to each other is driven by a plurality of servo motors controlled by a robot control system 48.

The robot control system 48 has a housing 50 that may be located outside the fence 20. The housing 50 encloses a control module and a drive module. The control module includes a robot controller 60, field-bus connections, and a safety interface. An operator panel with a display screen may be mounted on the exterior of the housing 50. The drive module includes a power supply, drive units of the robot 14 and an axis computer that regulates power feed to the servo motors. A gate box 52 with a status light 54 may be mounted proximate to the housing 50. The status light 54 provides a visual indication of the operating status of the robotic palletizing system 10, i.e., running, not running, malfunction, etc.

The robot controller 60 includes a central processing unit (CPU), memory and storage, such as one or more hard drives. The robot controller 60 is connected to the robot 14, such as by a plurality of cables, including a motor power cable, a measurement signal cable and one or more communication cables. In the robot controller 60, the CPU is operable to execute control software stored in memory to control the operation of the robot 14, including the gripper assembly 95. The control software is written in a robot user programming language (robot code), such as Karel, KRL or RAPID, all of which are based on the C programming language. In an embodiment of the present invention, the robot code is RAPID, which is used in robotic systems provided by ABB Inc. of Auburn Hills, Mich.

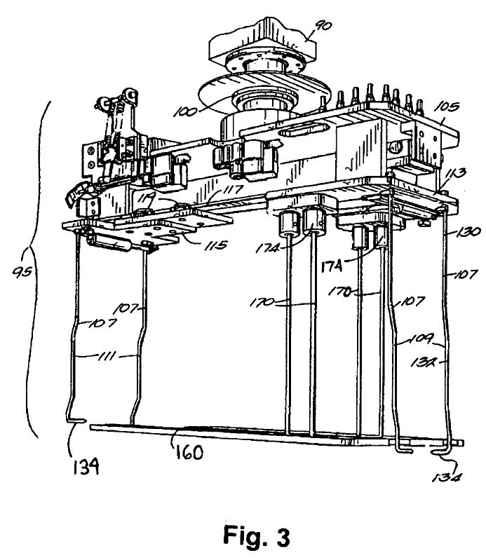

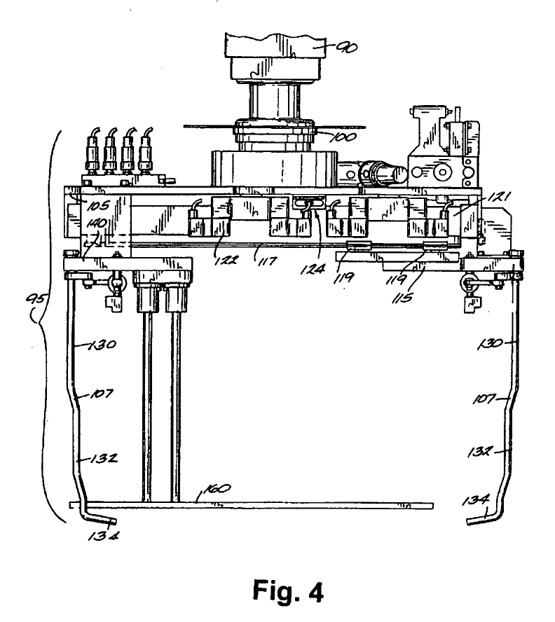

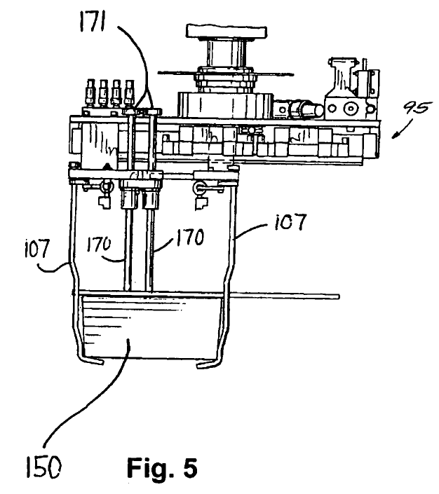

Referring now to FIGS. 3-5, the gripper assembly 95 may have substantially the same construction as the gripper disclosed in U.S. Pat. No. 6,579,053 and 6,866,471 to Grams et al., which are hereby incorporated by reference. In accordance with this construction, the gripper assembly 95 includes an arm 90 connected to the wrist 46 carried by the upper arm 40 of the robot 14. The arm 90 of the gripper assembly 95 is connected to a mounting plate 100 coupled to a main body 105. The main body 105 supports the other components of the gripper assembly 95. A first pair 109 of offset fingers 107 and a second pair 111 of offset fingers 107 are connected to the main body 105. More specifically, the first pair 109 is secured to a fixed plate 113 secured to the main body 105 and the second pair 111 is secured to a carriage 115 movably mounted to a track 117 on the main body 105. The carriage 115 is movable between a first or open position (shown in FIGS. 3 and 4) and a second or closed position (shown in FIG. 5). The closed position is dependent on the width of the object being grasped. The carriage 115 is coupled to the track 117 by a plurality of slides 119 and is moved by an actuator 121 coupled to the main body 105. The clamp force of the actuator 121 may be controlled using a valve 122, such as an open/closed air control valve, and a proximity switch 124, such as an intermediate-open proximity switch. The movement of the second pair 109 of fingers 107 allows the gripper assembly 95 to grasp and release a variety of differently sized objects.

Each finger 107 has a curved or offset configuration with a first straight portion 130, a second straight portion 132, and a bent tip 134, aligned at an angle of about 80 degrees with respect to the second straight portion 132. Each finger 107 is pivotally mounted to the fixed plate 113 or the carriage 115, as the case may be, so as to permit each pair 109, 111 of fingers 107 to pivot 90 degrees between a release position and a hold position. In the release position, the tips 34 of the fingers 107 within each pair 109, 111 are directed inward, toward each other. In the hold position, the tips 34 of the fingers 107 in the pair 109 are directed inward toward the tips 34 of the fingers 107 in the pair 111 (and vice versa). Each pair 109, 111 of fingers 107 is pivotally moved between the release and hold positions by an actuator (not shown) connected to the pairs 109, 111 of fingers 107 by a linkage (not shown).

A containment plate 160 is mounted between the pairs 109, 111 of the fingers 107 and is used to detect and measure the height of objects to be grasped and placed on the pallets 12. The containment plate 160 is shaped like an H and is sized and positioned such that it rides atop of any object grasped by the fingers 107. The containment plate 160 is movably mounted to the fixed plate 113 by two pairs of linear rods 170, which are fixed to the containment plate 160. The linear rods 170 extend upwardly from the containment plate 160 through passages in the fixed plate 113 and bearings 174 connected to the fixed plate 113. End caps 171 are secured to top ends of the rods 170, respectively. The rods 170 are slidable through the passages to permit relative vertical movement between the containment plate 160 and the fixed plate 113. This relative vertical movement is between an unloaded position and a loaded position. In the unloaded position, the end caps 171 abut the fixed plate 113. The loaded position is variable and is dependent on the height of the object being grasped.

The gripper assembly 95 is adapted to carry out the top loading of the pallets 12 under the control of the robot controller 60. When the arm assembly 26 of the robot 14 moves the gripper assembly 95 downward to grasp an object (such as the object 150) from a lift station 16 (as described in more detail below), the carriage 115 is in the open position and the fingers 107 are in the release position. As the gripper assembly 95 is moved downward over the object, the containment plate 160 comes in contact with the top of the object and is moved vertically upward by the object. When the tips 134 of the fingers 107 are disposed below the object, the downward motion of the arm assembly 26 is stopped, thereby stopping the upward movement of the containment plate 160. The carriage 115 is moved to the closed position and the fingers 107 are moved to the hold position underneath the object. At this point, the object is held laterally between the pairs 109,111 of the fingers 107 and is held vertically between the containment plate 160 and the tips 134 of the fingers 107.

With the object securely held by the gripper assembly 95 as described above, the arm assembly 26 then moves the gripper assembly 95 and the object to one of the pallets 12 and positions the gripper assembly 95 over a placement location for the object. The arm assembly 26 then moves the gripper assembly 95 downward to a predetermined release height (position) where the object is released from the gripper assembly 95. The object is released by moving the fingers 107 to the release position, moving the carriage 115 toward the open position to release the clamping pressure, and then moving the gripper assembly 95 upward, away from the release position. If any other object is located below the released object, the released object will settle on or nest in the lower object. After releasing the object, the arm assembly 26 moves the gripper assembly 95 upward. As the gripper assembly 95 moves upward, the containment plate 160 stays in place on top of the object, while the fixed plate 113 moves upward (with the arm assembly 26) and the rods 170 move through the passages in the fixed plate 113 and the bearings 174. When the end caps 171 abut the fixed plate 113, the delivered height of the object is reached. A proximity sensor (not shown) detects this abutment and the vertical position of the wrist is stored in memory of the robot controller 60. This vertical position is used by the robot controller 60 as one input into the calculation of the predetermined release height for a subsequent object that is to be placed on top of the just-released object.

As shown in FIG. 1, the robot 14 is disposed in the middle loading path 20b, between the outer loading paths 20a, 20c. With this location, the robot 14 is operable to unload objects from all three loading paths 20a, 20b, 20c and to thereafter load the objects onto pallets 12a, 12b, 12c, respectively, as will be described more fully below. Referring now back to FIG. 2, the robot 14 is supported on a horizontal plate 190 of the table 30 so as to be disposed above the lift station 16b and the conveyor section 18b, as well as the other lift stations 16a, 16c and conveyor sections 18a, 18c. The plate 190 is supported above the floor by two pairs of legs 192. The conveyor section 18b extends between the pairs of legs 192 and beneath the plate 190. The conveyor section 18b is spaced below the plate a sufficient distance to permit objects of less than a predetermined maximum height to be carried by the conveyor section 18b underneath the plate 190. The conveyor section 18b is connected to the middle lift station 16b at a juncture that is located at about a forward end of the table 30. Each conveyor section 18 comprises a frame 194 supporting a series of rods with rotatable roller wheels mounted thereto so as to form a conveying surface 196. Each frame 194 is constructed so as to have the conveying surface 196 slope downwardly from a feed location to a lift station 16. In this manner, objects that enter a conveyor section 18 at the feed location slide over the roller wheels to the lift station 16 through the operation of gravity. Of course, rollers (powered or un-powered) could be used instead of rolling wheels. Objects enter the feed locations of the conveyor sections 18a,b,c from a main conveyor (not shown) that is connected to the conveyor sections 18a,b,c at the feed locations. Deflector arms (not shown) may be movably mounted to the main conveyor to selectively direct objects onto the conveyor sections 18a,b,c, respectively.

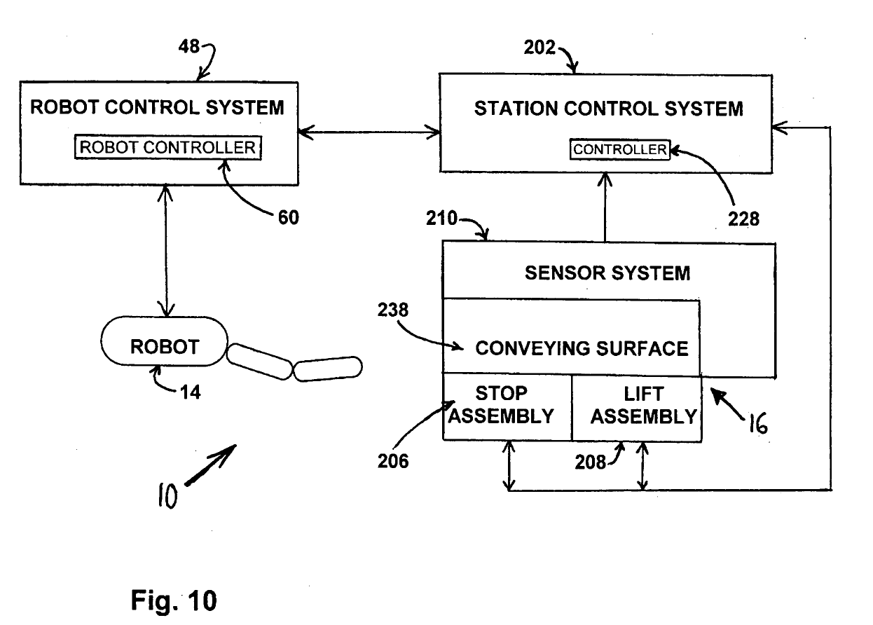

Referring now to FIGS. 2 and 6-10, a lift station 16 is shown and will be described below. For purposes of brevity, only one lift station 16 will be shown and described in detail, it being understood that each of the lift stations 16a, 16b, 16c has substantially the same construction and operation. The lift station 16 generally includes a frame 200, a station control system 202, a roller assembly 204, a stop assembly 206, a lift assembly 208 and a sensor system 210.

The frame 200 is rectangular and has anterior and posterior ends. The posterior end abuts its respective conveyor section 18. The frame 200 includes a stop wall 212 that is disposed at the anterior end and is connected between a pair of opposing first and second side walls 214, 216. A pair of first and second side rails 218, 220 are mounted to, and extend above, the first and second side walls 214, 216, respectively. The stop wall 212 and the first and second side walls 214, 216 are supported above the floor by a plurality of legs 222. Plates 224 may be secured between the legs 222 to close the bottom of the frame 200.

The station control system 202 includes a controller 228, such as a programmable logic controller (PLC). The controller 228 has a central processing unit (CPU) and memory. One or more input/output (I/O) modules are connected to the controller 228 by an internal bus. The controller 228 and the I/O modules are enclosed in a housing 226, which may be mounted to the table 30 (as shown). Alternately, the housing 226 with the controller 228 and the I/O module(s) may be mounted outside the fence 22, adjacent to the robot control system 48. The components of the station control system 202 may even be mounted in the same housing as the components of the robot control system 48. In the controller 228, the CPU executes a control program stored in memory to control the operation of the lift station 16. The control program may be written in one or more of the five IEC 61131-3 standard languages: Ladder Diagram, Structured Text, Function Block Diagram, Instruction List and Sequential Function Chart. The station control system 202 and the robot control system 48 are communicably connected together and interact with each other to control the robotic palletizing system 10.

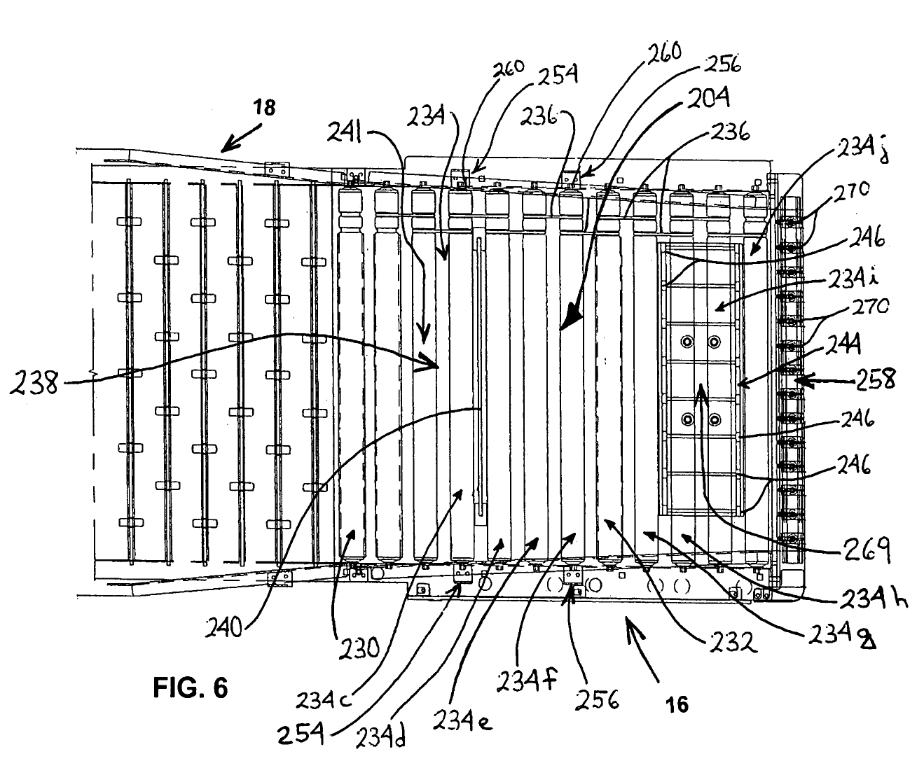

With particular reference now to FIG. 6, the roller assembly 204 includes a braking roller 230, a drive roller 232 and a plurality of idler rollers 234. As shown, there may be ten idler rollers 234, with the idler rollers 234 being numbered first through tenth in the direction from the braking roller 230 to the stop wall 212. The braking roller 230 is disposed at the posterior end and extends perpendicularly between the first and second side walls 214, 216. Opposing ends of the braking roller 230 are rotatably mounted to the first and second side walls 214, 216, respectively. The drive roller 232 is separated from the braking roller 230 by the first through sixth idler rollers 234 and is oriented parallel to the braking roller 230. Opposing ends of the drive roller 232 are rotatably mounted to the first and second side walls 214, 216, respectively. Toward a second end of the drive roller 232, a pair of circumferential grooves are formed in the drive roller 232. The idler rollers 234 are disposed between the braking roller 230 and the drive roller 232 and between the drive roller 232 and the stop wall 212. The idler rollers 234 are arranged in a spaced-apart manner and are positioned parallel to the braking roller 230 and the drive roller 232. Opposing ends of each idler roller 234 are rotatably mounted to the first and second side walls 214, 216, respectively. Toward a first end of each idler roller 234, inner and outer circumferential grooves are formed in the idler roller 234. The drive roller 232 is connected to the adjacent sixth and seventh idler rollers 234f, 234g by endless bands 236 that are disposed in the inner and outer circumferential grooves of the drive roller 232, respectively, and the inner and outer circumferential grooves of the sixth and seventh idler rollers 234f, 234g, respectively. In turn, the sixth idler roller 234f is connected to the fifth idler roller 234e by an endless band 236 that is disposed in the outer circumferential grooves of the sixth and fifth idler rollers 234f, 234g, and the seventh idler roller 234g is connected to the eighth idler roller 234h by an endless band 236 that is disposed in the inner circumferential grooves of the seventh and eighth idler rollers 234g, 234h. The other idler rollers 234 are connected to each other in a similar fashion, i.e., by endless bands 236 alternately disposed in the inner and outer circumferential grooves of adjacent idle rollers 234. In this manner, rotation of the drive roller 232 is transmitted by the bands 236 to the idler rollers 234 and causes them to rotate. The braking roller 230, the drive roller 232 and the idler rollers 234 form a conveying surface 238 over which objects are conveyed. The drive roller 232 is connected to and rotatably driven by an electric motor (not shown) that is electrically connected to and controlled by the station control system 202. Similarly, the braking roller 230 is connected to and rotatably driven by an electric motor (not shown) that is also electrically connected to and controlled by the station control system 202.

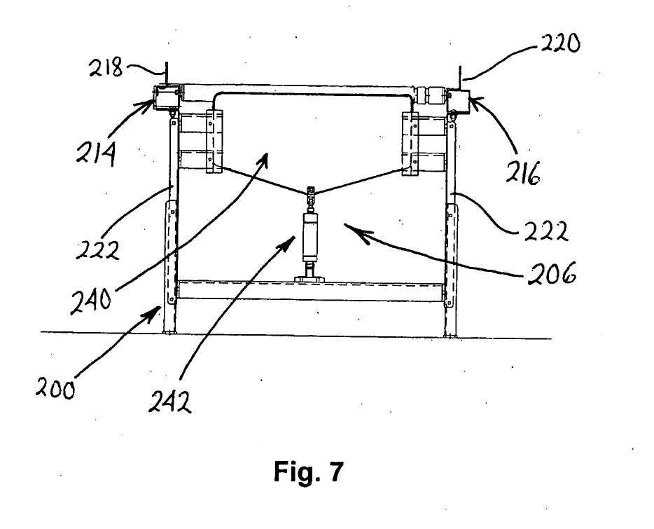

With particular reference now to both FIGS. 6 and 7, the stop assembly 206 includes a plate or blade 240 having a generally rectangular shape with a straight top edge and an angular bottom edge. The blade 240 is positioned so as to be movable between a third idler roller 234c and a fourth idler roller 234d. The portion of the conveying surface 238 disposed before the blade 240 (i.e., formed by the braking roller 230 and the first, second and third idler rollers 234a, 234b. 234c) may be referred to as a hold area 241. A bottom portion of the blade 240 is connected to an actuator 242 mounted to the frame 200. The actuator 242 is operable to move the blade 240 between a retracted position, wherein the top edge of the blade 240 is disposed just below top surfaces of the third and fourth idler rollers 234c, 234d, and an extended position, wherein the top edge is disposed above the top surfaces of the third and fourth idler rollers 234c, 234d, but below the first and second side rails 218, 220. When the blade 240 is in the extended position, the blade 240 blocks the travel of objects to the fourth idler roller 234d and subsequent idler rollers 234. The actuator 242 may be a double acting pneumatic cylinder and the supply of pressurized air to the pneumatic cylinder 242 may be controlled by one or more solenoid valves electrically connected to, and controlled by, the station control system 202.

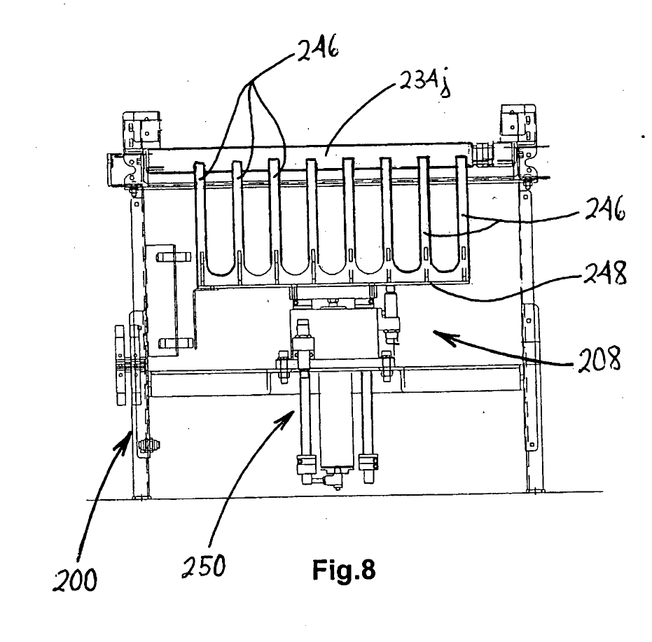

With particular reference now to FIGS. 6 and 8 the lift assembly 208 includes a lift cage 244 having spaced-apart first and second rows of fingers 246 that are joined to, and extend upward from, a horizontally disposed base plate 248. The lift cage 244 is sized and positioned so that each of the first and second rows of fingers 246 are disposed parallel to, and are movable between, a pair of the idler rollers 234, and so that one or more idler rollers 234 are disposed between the first and second rows of fingers 246. More specifically with regard to the shown embodiment, the second row of fingers 246 is movable between the ninth idler roller 234i and tenth idler roller 234j (i.e., between the last idler roller 234 and the penultimate idler roller 234) and the first row of fingers 246 is disposed between the seventh idler roller 234g and the eighth idler roller 234h. In this manner, two idler rollers (i.e., the eighth idler roller 234h and the ninth idler roller 234i) are disposed between the first and second rows of fingers 246. The base plate 248 is connected to an actuator 250 mounted to the frame 200. The actuator 250 is operable to move the lift cage 244 between a retracted position, wherein top ends of the fingers 246 are disposed just below top surfaces of the idler rollers 234, and an extended position, wherein the top ends of the fingers 246 are disposed above the first and second side rails 218, 220. When the lift cage 244 is in the extended position, the fingers 246 may support an object in a pick-up position which is located above the idler rollers 234 and from which the robot 14 may grasp the object, as will be described more fully below. The actuator 250 may be a pneumatic linear actuator having two movable shafts. The supply of pressurized air to the linear actuator may be controlled by one or more solenoid valves electrically connected to, and controlled by, the station control system 202.

The sensor system 210 generally includes a first side sensor 254, a second side sensor 256 and a front sensor bank 258.

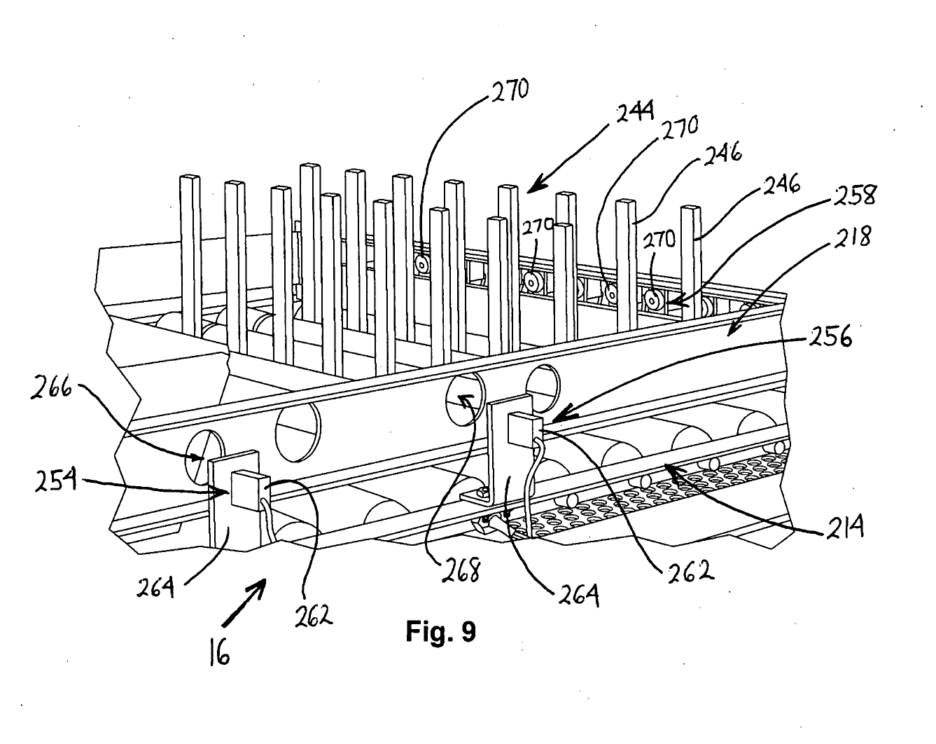

With particular reference now to FIG. 6 and FIG. 9, the first and second side sensors 254, 256 are communicably connected to the station control system 202 and are used to detect the presence of an object on the conveying surface 238 of the lift station 16. The first side sensor 254 is located above the third idler roller 234c, before the blade 240, while the second side sensor 256 is located above the sixth idler roller 234f, after the blade 240. Each of the first and second side sensors 254, 256 is a retro-reflective photosensor having a triple prism reflector 260 and a housing 262 with an emitter and a receiver. The housings 262 of the first and second side sensors 254, 256 are mounted to the first side wall 214 by brackets 264. The housing 262 of the first side sensor 254 is aligned with an opening 266 in the first side rail 218, while the housing 262 of the second side sensor 256 is aligned with an opening 268 in the first side rail 218. The reflectors 260 of the first and second side sensors 254, 256 are mounted to the second side wall 216 and are aligned with openings (not shown) in the second side rail 220. The reflectors of the first and second side sensors 254, 256 are mounted opposite to, and in alignment with the housings 262 of the first and second side sensors 254, 256, respectively. In each of the first and second side sensors 254, 256, the emitter transmits a pulsed infrared or red light beam that is reflected back from the reflector 260 and is received by the receiver. When the light beam is interrupted, such as by the presence of an object on the conveying surface 238, the side sensor generates a detection signal that is transmitted to the station control system 202. The first side sensor 254 is used to control the operation of the drive roller 232, while the second side sensor 256 is used to control the stop assembly 206.

It should be appreciated that in lieu of being retro-reflective sensors, the first and second side sensors 254, 256 may be through-beam sensors, wherein the receivers are disposed on an opposite side of the lift station 16 as the emitters.

The front sensor bank 258 is mounted to the stop wall 212 and faces rearward, toward the robot 14. The front sensor bank 258 is communicably connected to the station control system 202 and is used to detect the presence, location and size of an object in a lift area 269, which is located proximate to the stop wall 212. The front sensor bank 258 includes a plurality of spaced-apart diffused photosensors 270. As shown there may be fourteen photosensors 270. Each photosensor 270 includes a housing with an emitter and a receiver mounted therein. The emitter transmits a pulsed infrared or red light beam. When an object is present in front of the photosensor 270, the light is reflected back from the object and is received by the receiver. When the receiver receives reflected light back, the photosensor 270 is activated, i.e., generates a detection signal that is transmitted to the station control system 202. An identification routine within the control program determines the size and location of an object in the lift area 269.

The identification routine assumes that an object in the lift location is positioned so that its longitudinal axis extends in the direction between the first and second side walls 214, 216, i.e., is parallel to the idler rollers 234. The identification routine also assumes that the object is one of a plurality of predetermined types of objects, wherein each type of object has a unique predetermined length. Using these assumptions, the identification routine determines the length, and, thus, the type of object located in the lift area 269 from the number of consecutive photosensors 270 that indicate the presence of an object. The photosensors 270 are substantially evenly spaced apart and are separated by a distance that is sufficient to permit the identification routine to distinguish between the different lengths of the different types of objects. In the shown embodiments, the distance between the diffused photosensors 270 is from about three quarters of an inch to about an inch and a half. Thus, by way of example, the identification routine may look for two types of objects, namely a first type that is twice as long as a second type. The first type of object may have a length of ten consecutive activated photosensors 270 and the second type of object may have a length of five consecutive activated photosensors 270. If an object is in the lift area 269 and ten consecutive photosensors 270 are activated, the identification routine determines that the object is of the first type, whereas if an object is in the lift area 269 and five consecutive photosensors 270 are activated, the identification routine determines that the object is of the second type. If an object is in the lift area 269 and only four consecutive photosensors 270 are activated, the identification routine determines that there is an error. The object may not be properly aligned, e.g., is disposed at angle; the object may not be of the first or second type, i.e., is foreign and should not be present; or some of the photosensors 270 may not be working properly. In the event an error is detected, the identification routine may stop the operation of the robotic palletizing system 10.

Although only two differently sized objects are described above, it should be appreciated that the identification routine and the front sensor bank 258 can be used to identify more than two differently sized objects. For example, the identification routine and the front sensor bank 258 may be used to identify three, four, etc. differently sized objects.

The identification routine determines the position of an object in the lift area 269 simply from the lateral location of the consecutively activated photosensors 270. For example, if the consecutively-activated photosensors 270 are centered, the identification determines that the object is laterally centered.

When an object is in the lift area 269, the identification routine determines the type of the object and its location and then transmits this information to the robot control system 48 so that the robot controller 60 can guide the robot 14 to pick up the object and move the object to a pallet 12 or a hold location, as will be described more fully below.

As set forth above, the operation of the robotic palletizing system 10 is controlled by the station control system 202 and the robot control system 48. The control program in the station control system 202 includes control routines for controlling the roller assembly 204, the stop assembly 206 and the lift assembly 208.

The control routine for the drive roller 232 is operable to stop the rotation of the drive roller 232 when the first side sensor 254 detects an object in the hold area 241 and the blade 240 is in the extended position. When the first side sensor 254 detects an object in the hold area 241 and the blade 240 is in the retracted position, the drive roller control routine starts the rotation of the drive roller. When the first side sensor 254 does not detect an object, the drive roller control routine rotates the drive roller 232.

The control routine for the braking roller 230 is operable to stop the rotation of the braking roller 230 when the first side sensor 254 detects an object in the hold area 241. The control routine further requires the blade 240 to be in the extended position and the hold area 241 clear of objects to rotate the braking roller 230.

The control routine for the stop assembly 206 is operable to move the blade 240 to the retracted position when the lift cage 244 of the lift assembly moves from the extended position to the retracted position. The control routine may further require that the first side sensor 254 detect an object in the hold area 241 before the control routine moves the blade 240 to the retracted position. When the second side sensor 256 detects the passage of an object along the conveying surface 238, the stop assembly control routine moves the blade 240 from the retracted position to the extended position.

The control routine for the lift assembly 208 is operable to move the lift cage 244 from the retracted position to the extended position when the identification routine, using inputs from the front sensor bank 258, determines that an object of a predetermined type is in the lift area 269. When the lift cage 244 is in the extended position with the object supported on the fingers 246, the lift assembly control routine notifies the robot control system 48 that an object is in the pick-up position, waiting to be removed by the robot 14. After the robot 14 removes the object from the lift cage 244, the robot control system 48 notifies the lift assembly control routine, which, in response, moves the lift cage 244 to the retracted position.

The overall operation of the robotic palletizing system 10 during a pallet loading operation will now be described. For purposes of description, it will be assumed that the robotic palletizing system 10 handles the two types of objects discussed above, namely the first and second types, each of which may be a mail tray of varying overall dimensions. It will be assumed that at least the first several objects are of the first type. At the beginning of the pallet loading operation, the robot 14 is in a safe or rest position, the drive roller is rotating and the lift cage 244 is in the retracted position. The blade 240 may be in the extended position or the retracted position. For ease of description, however, it will be assumed that the blade 240 is in the retracted position. Objects move down the conveyor section 18 through the operation of gravity to the lift station 16. The drive roller moves a lead object to the lift area 269. When the lead object passes the second side sensor 256, the stop assembly control routine moves the blade 240 to the extended position, thereby preventing subsequent objects from moving into the lift area 269. The first side sensor 254 detects the presence of a second object, which is now abutting the blade 240. Meanwhile, the identification routine, using inputs from the front sensor bank 258, determines that the lead object is in the lift area 269 and causes the drive roller control routine to stop the rotation of the drive roller 232. The identification routine also determines the location of the lead object and its type (the first type). The identification routine transmits this information to the robot control system 48. In response to the detection of the object by the identification routine, the lift assembly control routine moves the lift cage 244 (with the lead object supported on the fingers 246) to the extended position so as position the lead object in the pick-up position. The lift assembly control routine notifies the robot control system 48 that the lead object is in the pick-up position, waiting to be removed by the robot 14. The robot 14, knowing the position and type of the lead object, moves to the pick-up position and removes the lead object from the lift cage 244 with the gripper assembly 95. The robot 14 moves the lead object to a pallet 12 and places the lead object in a first position on the pallet 12. The robot 14 then returns to the rest position. The first position and the positions of subsequent objects loaded onto the pallet 12 are predetermined, in accordance with a predetermined stacking configuration. The movement of the robot 14 between the pick-up position and the pallet 12 to form the stacking configuration is controlled by a software load routine stored in the memory of the robot controller 60 and executed by the CPU of the robot controller 60.

After the robot control system 48 notifies the lift assembly control routine that the object has been removed from the lift cage 244, the lift assembly control routine moves the lift cage 244 to the retracted position. The movement of the lift cage 244 to the retracted position causes the stop assembly control routine to move the blade 240 to the retracted position. When the blade 240 moves to the retracted position, the braking roller control routine briefly rotates the braking roller to begin movement of the second object and the drive roller controller routine rotates the drive roller 232 to move the second object to the lift area 269. The operation of the robotic palletizing system 10 then proceeds as described above with regard to the lead object. The second side sensor 256 detects the passage of the second object, which then causes the blade 240 to move to the extended position. The lift cage 244 moves to the extended position, the robot 14 removes the second object from the lift cage 244 and then the robot 14 loads the second object on the pallet 12. This operation continues in the same manner until the identification routine determines that an object is of the second type.

When the identification routine notifies the load routine in the robot control system 48 that an object of the second type is in the lift area 269, the load routine causes the robot 14 to move the object of the second type to a holding area instead of to the pallet 12. The operation of the robotic palletizing system 10 then continues as described above until a second object of the second type is determined to be in the lift area 269. At this point, the load routine causes the robot 14 to move the object of the second type from the pick-up position to the pallet 12. The load routine then causes the robot 14 to move the object of the second type that is in the holding area to the pallet 12, in a position adjacent to the object of the second type already on the pallet 12. In this manner, the load routine, in essence, forms an object of the first type from two objects of the second type.

While the invention has been shown and described with respect to particular embodiments thereof, those embodiments are for the purpose of illustration rather than limitation, and other variations and modifications of the specific embodiments herein described will be apparent to those skilled in the art, all within the intended spirit and scope of the invention. Accordingly, the invention is not to be limited in scope and effect to the specific embodiments herein described, nor in any other way that is inconsistent with the extent to which the progress in the art has been advanced by the invention.

What is claimed is:

1. A robotic palletizing system for receiving objects from a conveyor and loading the objects on a support structure, the robotic palletizing system comprising:
a robot including a base, an articulated arm assembly mounted to the base and a gripping device connected to the articulated arm assembly;
a lift station located below the base of the robot, the lift station comprising:
a conveying path over which the objects may move, the conveying path having a hold area and a lift area;
a stop assembly having a barrier movable between a blocking position, wherein the barrier obstructs movement over the conveying path between the hold area and the lift area, and a release position, wherein the barrier does not obstruct movement over the conveying path between the hold area and the lift area;
a lift assembly having a lift operable to raise any of the objects located in the lift area above the conveying path to a pick position from which the robot can grasp the object with the gripping device; and
a control system connected to the stop assembly and the lift assembly and operable to control the movement of the barrier from the release position to the blocking position to prevent any of the other objects from moving from the hold area to the lift area when the lift is raising the object to the pick position.

2. The robotic palletizing system of claim 1, further comprising a sensor system connected to the control system, the sensor system including a sensor operable to detect any of the objects passing from the hold area to the lift area.

3. The robotic palletizing system of claim 2, wherein the control system is operable to control the stop assembly to move the barrier to the blocking position when the sensor detects any of the objects passing from the hold area to the lift area.

4. The robotic palletizing system of claim 3, wherein the sensor is a first sensor and wherein the sensor system further comprises a sensor arrangement disposed proximate to the lift area, the sensor arrangement being operable to detect the presence of any of the objects in the lift area.

5. The robotic palletizing system of claim 4, wherein the objects have different sizes, and wherein the sensor arrangement is also operable to provide the control system with information from which the control system can determine the location and size of any of the objects located in the lift area.

6. The robotic palletizing system of claim 5, wherein the sensor arrangement comprises a row of spaced-apart sensors, and wherein the control system determines the location and the size of any of the objects in the lift area from the number and location of the sensors that detect the presence of the object.

7. The robotic palletizing system of claim 4, wherein the conveying path comprises a plurality of rollers comprising at least one drive roller and a plurality of idler rollers, the at least one drive roller being connected to the idler rollers to rotate the idler rollers.

8. The robotic palletizing system of claim 7, wherein the sensor system further comprises a second sensor that is operable to detect the presence of any of the objects in the hold area, and wherein the control system is operable to control the drive roller to stop the rotation of the drive roller when the second sensor detects the presence of any of the objects in the hold area.

9. The robotic palletizing system of claim 7, wherein the stop assembly further comprises an actuator that is connected to the barrier and is operable to vertically move the barrier, the barrier being movable between a pair of the rollers; and
wherein the lift assembly further comprises an actuator that is connected to the lift and is operable to vertically move the lift, the lift comprising a base plate having a plurality of fingers extending upwardly therefrom, the fingers being vertically movable between at least one pair of the rollers.

10. A robotic palletizing system for receiving objects from a conveyor and loading the objects on a support structure, the robotic palletizing system comprising:
a plurality of conveying paths over which the objects may move, the conveying paths being spaced-apart and each comprising a lift station having a lift for lifting the objects to a pick position;
a table through which at least one of the conveying paths extend; and
a robot including a base, an articulated arm assembly mounted to the base and a gripping device connected to the articulated arm assembly, the robot being mounted on top of the table and operable to grasp the objects from the pick positions at the lift stations.

11. The robotic palletizing system of claim 10, wherein each lift station further comprises:
a stop assembly having a barrier movable between a blocking position, wherein the barrier obstructs movement over the conveying path between a hold area and a lift area on the conveying path, and a release position, wherein the barrier does not obstruct movement over the conveying path between the hold area and the lift area; and
a control system connected to the stop assembly and the lift assembly and operable to control the movement of the barrier from the release position to the blocking position to prevent any of the other objects from moving from the hold area to the lift area when the lift is raising one of the objects to the pick position.

12. The robotic palletizing system of claim 11, wherein each of the conveying paths comprise a plurality of rollers, the rollers comprising at least one drive roller and a plurality of idler rollers, the at least one drive roller being connected to the idler rollers to rotate the idler rollers.

13. The robotic palletizing system of claim 12, wherein each of the lift stations further comprises a sensor system connected to the control system and comprising:
a first sensor operable to detect any of the objects passing from the hold area to the lift area;
a second sensor that is operable to detect the presence of any of the objects in the hold area; and
a sensor arrangement disposed proximate to the lift area, the sensor arrangement being operable to detect the presence of any of the objects in the lift area and to provide the control system with object information; and
wherein the control system is operable to:
control the stop assembly to move the barrier to the blocking position when the first sensor detects any of the objects passing from the hold area to the lift area;
control the drive roller to stop the rotation of the drive roller when the second sensor detects the presence of any of the objects in the hold area; and
determine the location and size of any of the objects located in the lift area using the object information from the sensor arrangement.

14. The robotic palletizing system of 12, wherein in each of the lift stations, the stop assembly further comprises an actuator that is connected to the barrier and is operable to vertically move the barrier, the barrier being movable between a pair of the rollers; and
wherein in each of the lift stations, the lift assembly further comprises an actuator that is connected to the lift and is operable to vertically move the lift, the lift comprising a base plate having a plurality of fingers extending upwardly therefrom, the fingers being vertically movable between at least one pair of the rollers.

15. A lift station for receiving objects of different sizes from a conveyor and presenting them for pick-up by a robot, the lift station comprising:
(a.) a conveying path over which the objects may move, the conveying path having a hold area and a lift area;
(b.) a stop assembly having a barrier movable between a blocking position, wherein the barrier obstructs movement over the conveying path between the hold area and the lift area, and a release position, wherein the barrier does not obstruct movement over the conveying path between the hold area and the lift area;
(c.) a lift assembly having a lift operable to raise any of the objects located in the lift area above the conveying path to a pick position from which the robot can grasp the object;
(d.) a sensor assembly comprising:
a first sensor operable to detect any of the objects passing from the hold area to the lift area;
a sensor arrangement disposed proximate to the lift area, the sensor arrangement being operable to detect the presence of any of the objects in the lift area and to transmit object information; and
(e.) a control system connected to the stop assembly, the lift assembly and the sensor assembly, the control system being operable to:
control the movement of the barrier from the release position to the blocking position to prevent any of the other objects from moving from the hold area to the lift area when the lift is raising one of the objects to the pick position; and
determine the location and size of any of the objects located in the lift area using the object information from the sensor arrangement.

16. The lift station of claim 15, wherein the sensor arrangement comprises a row of spaced-apart sensors, and wherein the object information includes the number and location of the sensors that detect the presence of the object.

17. The lift station of claim 15, wherein the conveying path comprises a plurality of rollers comprising at least one drive roller and a plurality of idler rollers, the at least one drive roller being connected to the idler rollers to rotate the idler rollers.

18. The lift station of claim 17, wherein the sensor system further comprises a second sensor that is operable to detect the presence of any of the objects in the hold area, and wherein the control system is operable to control the drive roller to stop the rotation of the drive roller when the second sensor detects the presence of any of the objects in the hold area.

19. The lift station of claim 17, wherein the stop assembly further comprises an actuator that is connected to the barrier and is operable to vertically move the barrier, the barrier being movable between a pair of the rollers; and
wherein the lift assembly further comprises an actuator that is connected to the lift and is operable to vertically move the lift, the lift comprising a base plate having a plurality of fingers extending upwardly therefrom, the fingers being vertically movable between at least one pair of the rollers.

20. The lift station of claim 19, wherein the fingers are arranged in a pair of rows, and wherein at least one roller is disposed between the rows of the fingers.
